(19) United States
(12) Patent Application Publication
(10) Pub. No.: US 2004/0104862 A1
(43) Pub. Date: Jun. 3, 2004

(54) Information processing apparatus and display device swetching method

(75) Inventor: Yohzoh Ogura, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/650,779

(22) Filed: Aug. 29, 2003

(30) Foreign Application Priority Data
Nov. 28, 2002 (JP) 2002-345859

(51) Int. Cl. G09G 5/00

(52) U.S. Cl. 345/1.1

(57) ABSTRACT

A graphics controller acquires, from an external display device, information which is set in the display device and is required to determine the availability/non-availability of a display switching process, upon reception of a display switching instruction command from a CPU via a graphic memory controller hub. The graphics controller determines based on the acquired information and information of contents, which are to undergo the display switching process and held by the graphics controller, if the display switching process can be immediately executed in the current state.

### CROSS-REFERENCE TO RELATED APPLICATIONS

This application is based upon and claims the benefit of priority from the prior Japanese Patent Application No. 2002-345859, filed Nov. 28, 2002, the entire contents of which are incorporated herein by reference.

### BACKGROUND OF THE INVENTION

1. Field of the Invention

The present invention relates to an information processing apparatus which comprises a connection interface of an external display device, and a display device switching method.

2. Description of the Related Art

A computer system has a function of switching and displaying an image displayed on a display device as standard equipment (to be referred to as an internal display hereinafter) to and on an external display specified in advance (Jpn. Pat. Appln. KOKAI Publication No. 1-248185).

However, such conventional display device switching mechanism uniquely executes a display switching process in accordance with a display switching request. When the display switching process is not available, the mechanism merely invalidates the request, but has no means for notifying the user of each states.

For this reason, the user cannot recognize a state wherein the display switching process is in progress, a state wherein the display switching process is currently not available, and the like. Especially, when the display switching process is executed for display contents (e.g., DVD software), a display device, or the like having a copy protection function, a process for determining the availability/non-availability of that display switching process, a display information acquisition process in a state wherein the display switching process is available, and the like are indispensable. However, aforementioned mechanism cannot notify the user of the states corresponding to these processes.

As described above, with the conventional mechanism, upon switching and displaying an image displayed on the internal display to and on the external display specified in advance, the user cannot recognize the state wherein the display switching process is in progress, the state wherein the display switching process is currently not available, and the like.

### BRIEF SUMMARY OF THE INVENTION

The embodiment according to the present invention is characterized by comprising a processing function of displaying a wait screen on a display device before display switching upon executing the display device switching process. Also, the embodiment according to the present invention is characterized by comprising a processing function of visibly, audibly, or visibly and audibly notifying the user of the display device switching state.

That is, the embodiment according to the present invention is characterized by an information processing apparatus comprising a display device, a connection interface for an external display device, instruction means which can generate a signal for displaying an image displayed on the display device on the external display device connected via the connection interface, and display control means for, when the image is displayed on the external display device in response to the signal generated by the instruction means, displaying specific information on the display device.

With the aforementioned processing functions of the embodiment according to the present invention, the user can recognize the state of the switching process upon executing the display device switching process. Hence, user's operation errors, repetitive operations, and the like can be avoided in the display device switching process, thus improving the usability.

Additional advantages of the invention will be set forth in the description which follows, and in part will be obvious from the description, or may be learned by practice of the embodiment according to the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below serve to explain the principles of the invention.

FIG. 1 is a view for explaining an outline of an embodiment of the present invention;

FIG. 2 is a view for explaining an outline of an embodiment of the present invention;

FIG. 3 is a perspective view showing the outer appearance of an information processing apparatus in the first and second embodiments of the present invention;

FIG. 4 is a block diagram showing the system arrangement of a computer in the first and second embodiments of the present invention;

FIG. 5 is a flow chart showing a display device switching processing sequence according to the first embodiment of the present invention; and

FIG. 6 is a flow chart showing a display device switching processing sequence according to the second embodiment of the present invention.

### DETAILED DESCRIPTION OF THE INVENTION

Preferred embodiments of the present invention will be described hereinafter with reference to the accompanying drawings.

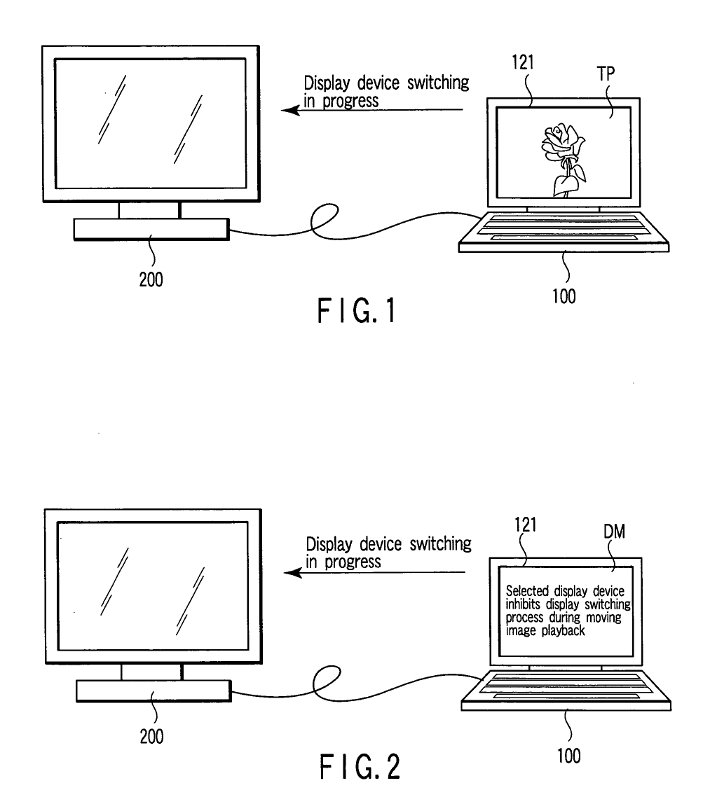

An outline of an embodiment of the present invention will be described first with reference to FIGS. 1 and 2. FIGS. 1 and 2 depict an example wherein an external display monitor (to be referred to as an external display device hereinafter) is connected to a display connection terminal of a personal computer which comprises a display device (to be referred to as an internal display device hereinafter), and an image currently displayed on the internal display device is switched to and displayed on the external display device.

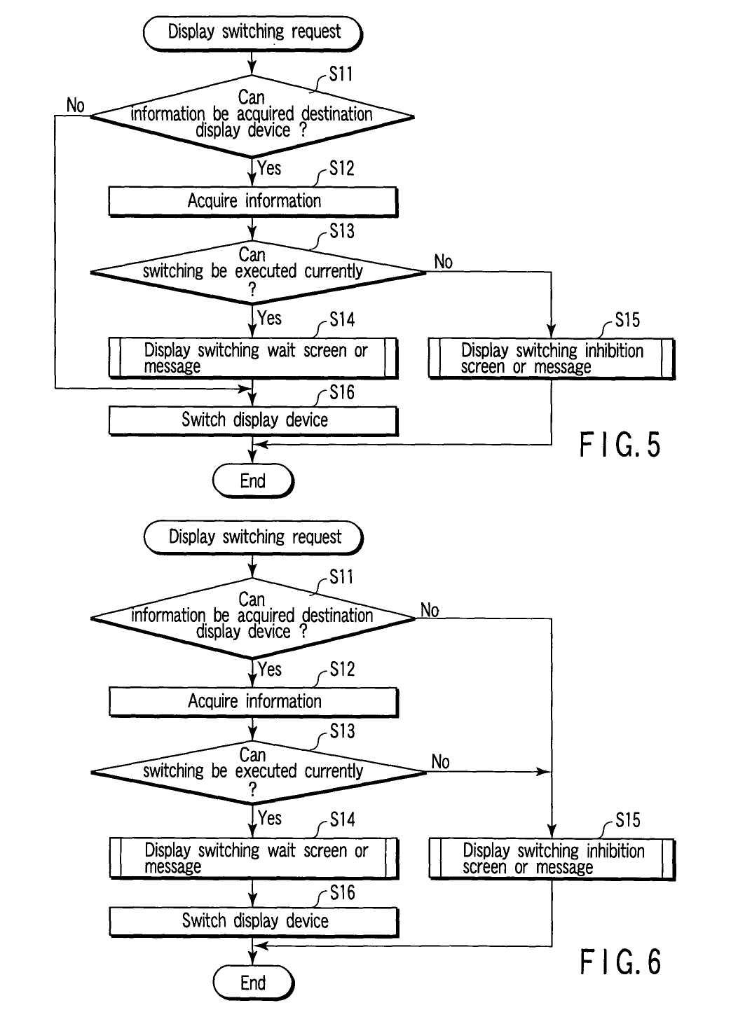

In FIGS. 1 and 2, when an image which is currently displayed on an internal display device 121 provided to a computer 100 is switched to and displayed on an external display device 200, a processing device of the computer 100 executes an acquisition process of information required to check the availability/non-availability of a display switching process to the external display device. If this information cannot be acquired, the processing device uniquely executes a display switching process in accordance with predetermined rules (see FIG. 5), or inhibits the display switching process (see FIG. 6).

If the information can be acquired, it is checked based on the acquired information, information of contents which are to undergo the display switching process, and the like if the display switching process is available. If the display switching process is available, the display switching process is executed, and a wait screen (TP) which is prepared in advance is displayed on the internal display device 121 before display switching, as shown in FIG. 1.

If it is determined that the display switching process is not available, information (DM) representing that the display switching process is not available is displayed on the internal display device 121 without executing the display switching process, as shown in FIG. 2.

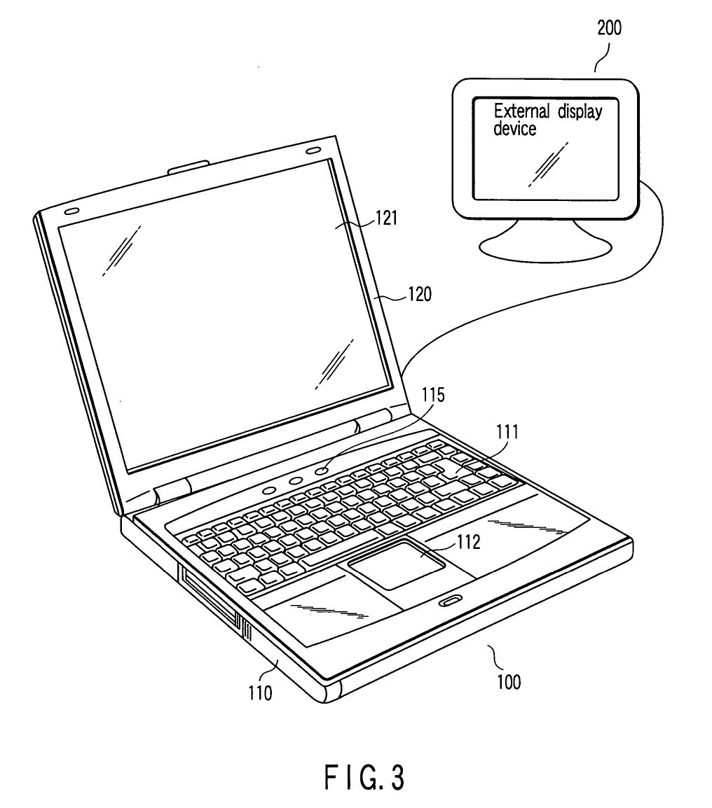

Embodiments of the present invention, which implement the display switching function shown in FIGS. 1 and 2, will be described below with reference to FIGS. 3 to 6.

FIG. 3 is a perspective view showing the outer appearance of an information processing apparatus in the embodiment of the present invention. FIG. 3 exemplifies a notebook type personal computer.

The computer 100 according to the embodiment of the present invention shown in FIG. 3 comprises a computer main body 110 and a display unit (display unit housing) 120. The external display device 200 using, e.g., a CRT, is connected to the computer main body 110 via an external display connection interface (to be described later).

A display device using an LCD is built in the display unit 120 as the internal display device 121. This display unit 120 is attached to the computer main body 110 to be pivotal between the open and close positions.

The computer main body 110 has a low-profile box-shaped housing. A keyboard unit 111 is arranged on the upper surface of this housing, and an armrest is formed on the upper surface of the housing in front of the keyboard unit 111. A touch panel 112 is provided to nearly the central portion of this armrest. Also, an operation button (to be referred to as a presentation button hereinafter) 115 used to instruct the display switching process of the display device is provided to the upper surface of the housing where the keyboard unit 111 is arranged.

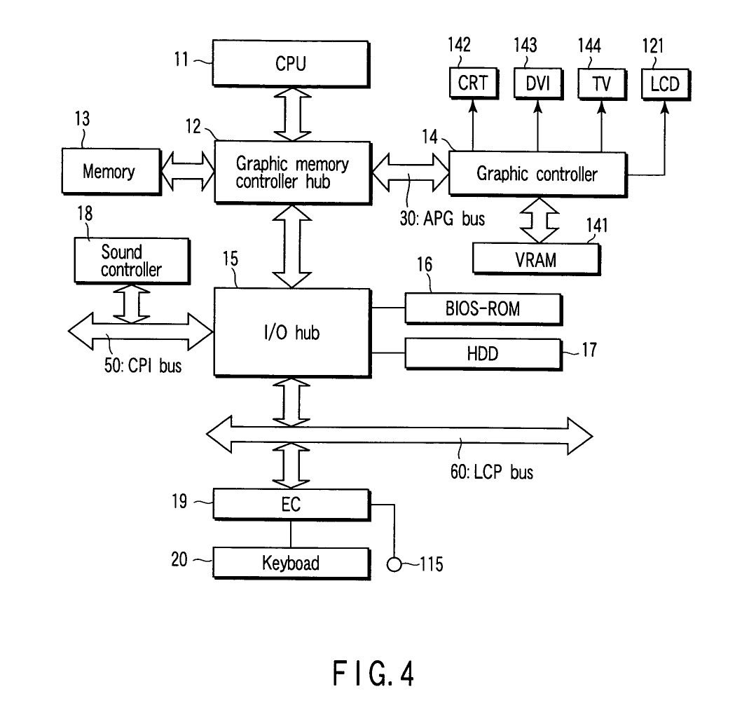

FIG. 4 is a block diagram showing the system arrangement of the computer shown in FIG. 3. This computer system is a battery-driven, notebook type portable personal computer, and comprises a CPU 11, graphic memory controller hub 12, memory 13, graphics controller 14, VRAM 141, I/O hub 15, BIOS-ROM 16, hard disk drive (HDD) 17, sound controller 18, embedded controller (EC) 19, keyboard 20, and the like, as shown in FIG. 4.

The graphics controller 14 executes display drive control of the internal display device (LCD) 121 under the control of an OS executed by the CPU 11, and also executes display drive control of an external display device connected via each of various external display connection interfaces such as a CRT terminal 142, DVI terminal 143, TV (television) terminal 144, and the like.

The embedded controller (EC) 19 notifies the CPU 11 of a display switching instruction request upon depression of the presentation button 115.

The CPU 11 controls the operation of this computer. The CPU 11 executes various processes in accordance with an operating system (OS), application programs, utility programs, and the like, which are loaded from the hard disk drive (HDD) 17 onto the main memory 13. In this embodiment, upon reception of a display switching request from the embedded controller (EC) 19 upon depression of the presentation button 115, upon operation of a specific key on the keyboard (KB) 20, upon operation of a specific icon displayed on the internal display device (LCD) 121, or the like, the CPU 11 issues a display switching instruction command that follows the request to the graphics controller 14 under the control of the OS.

The graphics controller 14 executes a display device switching process shown in FIG. 5 or 6 upon receiving the display switching instruction command from the CPU 11 via the graphic memory controller hub 12.

FIG. 5 is a flow chart showing a display device switching process sequence according to the first embodiment of the present invention. This sequence is executed when the graphics controller 14 receives a display switching instruction command from the CPU 11.

FIG. 6 is a flow chart showing a display device switching process sequence according to the second embodiment of the present invention. This sequence is executed when the graphics controller 14 receives a display switching instruction command from the CPU 11, as in the first embodiment.

The operations in the first and second embodiments will be described below with reference to FIGS. 5 and 6.

An arbitrary external display device 200 is connected to the computer main body 110 via an external display connection interface (142, 143, 144). Assume that a CRT display of various external display devices (CRT display, external LED, television) connected to the external display connection interfaces (142, 143, 144) is connected to the computer main body 110 via the connection interface 142 as the external display device 200.

The display device switching process in the first embodiment of the present invention is executed in the processing sequence shown in FIG. 5.

When the CPU 11 receives a display switching request issued, e.g., upon depression of the presentation button 115, it issues a display switching instruction command that follows the request to the graphics controller 14 under the control of the OS.

Upon receiving the display switching instruction command from the CPU 11 via the graphic memory controller hub 12, the graphics controller 14 executes the display device switching process shown in FIG. 5, as will be described below.

In this process, the graphics controller 14 makes predetermined access to the external display device 200 connected via the external display connection interface 142, and checks if information required to determine the availability/non-availability of the display switching process can be acquired from the external display device 200 (step S11 in FIG. 5). If it is determined that the information can be acquired (YES in step S11 in FIG. 5), the graphics controller 14 acquires, from the external display device 200, the information which is set in that display device and is required to determine the availability/non-availability of the display switching process (step S12 in FIG. 5). The detailed contents of the acquired information in this case will be described later.

The graphics controller 14 checks based on the contents of the acquired information, information of contents, which are to undergo the display switching process and held by itself, and the like if the display switching process can be immediately executed under the current state (step S13 in FIG. 5).

Of the information used to determine if the display switching process can be immediately executed under the current state (step S13 in FIG. 5), the information acquired from the external display device 200 includes, for example, the resolution, refresh rate, connection & operation status, copy protect (copy guard) function, owner information, and the like of the display device. On the other hand, the information held by the graphics controller 14 includes, for example, various kinds of management, restriction, limitation, and control information (copy guard, age limit, restriction and control information for respective scenes, and the like) upon moving image playback of each individual contents such as a DVD or the like. Based on such information, it is determined if the display switching process can be immediately executed under the current state.

If it is determined that the display switching process can be executed (YES in step S13 in FIG. 5), a wait screen image, which is prepared in advance in the memory 13 (or the HDD 17 as an external storage), is mapped on the VRAM 14, and the wait screen (TP) shown in, e.g., FIG. 1 is displayed on the internal display 121 before display switching (step S14 in FIG. 5), thus executing the display switching process from the internal display 121 to the external display device 200 (step S16 in FIG. 5).

If it is determined that the display switching process cannot be immediately executed in the current state (NO in step S13 in FIG. 5), a screen or message information (DM) indicating that the switching process cannot be executed, as shown in FIG. 2, is displayed on the internal display 121 (step S15 in FIG. 5), thus ending the display device switching process according to the request.

On the other hand, if it is determined that information required to determine the availability/non-availability of the display switching process cannot be acquired from the external display device 200 (NO in step S1 in FIG. 5), the display switching process from the internal display 121 to the external display device 200 is uniquely executed (step S16 in FIG. 5), thus ending the process.

The display device switching process in the second embodiment of the present invention is executed in the processing sequence shown in FIG. 6.

In the second embodiment, a process particularly different from that in the first embodiment in the processing sequence shown in FIG. 5 is as follows. In the first embodiment, if it is determined that information required to determine the availability/non-availability of the display switching process cannot be acquired from the external display device 200 (NO in step S1 in FIG. 5), the display switching process from the internal display 121 to the external display device 200 is uniquely executed (step S16 in FIG. 5). Alternatively, in the second embodiment, if it is determined that information cannot be acquired (NO in step S11 in FIG. 6), a screen or message information (DM) indicating that the switching process cannot be executed, as shown in FIG. 2, is displayed on the internal display 121 (step S15 in FIG. 6), thus ending the display device switching process according to the request. In this way, the user can immediately recognize a state and reason why a display switching request is not accepted, and the like upon making the display switching request operation.

In each of the above embodiments, the wait screen (TP) or the screen or message information (DM) indicating that the switching process cannot be executed is displayed on the internal display 121 to notify the user of the state of the process according to the display device switching request. For example, in place of or in addition to the visible notification on the screen, a voice message may be generated to notify the user of the state of the process according to the display device switching request. In this case, the sound controller 18 is enabled in synchronism with the display timing of the screen under the control of the CPU 11, thus outputting a voice message corresponding to the display screen.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a display device;
a connection interface for an external display device;
means for generating a signal for displaying an image displayed on the display device on the external display device connected via the connection interface; and
means for, when the image is displayed on the external display device in response to the signal generated by the generating means, displaying specific information on the display device.

2. An apparatus according to claim 1, wherein the display means comprises means for, when the image displayed on the display device is displayed on the external display device, executing a process for acquiring predetermined information from the external display device, and reflecting the predetermined information on the specific information.

3. An apparatus according to claim 1, wherein the display means determines if a display switching process to the external display device is available upon displaying the image displayed on the display device on the external display device, and displays a specific screen according to the determination result on the display device.

4. An apparatus according to claim 3, wherein the display means determines if the display switching process to the external display device is allowed based on information about the external display device.

5. An apparatus according to claim 2, wherein the executing means comprises means for, when the predetermined information can be acquired from the external display device, determining if a display switching process to the external display device is available based on the acquired predetermined information.

6. An apparatus according to claim 2, wherein the executing means comprises:
means for, when the predetermined information can be acquired from the external display device, determining if a display switching process to the external display device is available based on the acquired predetermined information,
means for, when the display switching process is available, displaying a wait screen prepared in advance on the display device during a display switching period, and
means for, when the display switching process is not available, displaying information which indicates that the display switching process is not available on the display device.

7. A display switching method of an information processing apparatus, comprising:
displaying specific information with regard to display switching on a first display device; and
displaying an image which is currently displayed on the first display device of the information processing apparatus on a second display device externally connected to the information processing apparatus.

8. A display switching method of an information processing apparatus, comprising:
determining, when an image which is currently displayed on a first display device of the information processing apparatus is displayed on a second display device externally connected to the information processing apparatus, if the image can be displayed on the second display device, and
displaying, when the image cannot be displayed on the second display device, specific information on the first display device.

9. A method according to claim 8, further comprising:
displaying, when the image can be displayed on the second display device, a wait image on the first display device until a display switching process to the second display device is completed.

10. A method according to claim 7, wherein the step of displaying the image is executed based on information about the external display device.

11. A method according to claim 7, wherein the step of displaying the image comprises:
executing a process for acquiring predetermined information from the second display device upon displaying the image on the second display device;
determining, when the predetermined information can be acquired from the second display device, if a display switching process to the second display device is available;
displaying, if the display switching process is available, a first image on the first display device; and
displaying, if the display switching process is not available, a second image which represents that the display switching process is not available on the first display device.
